(19) United States
(12) Patent Application Publication
(10) Pub. No.: US 2015/0178255 A1
(43) Pub. Date: Jun. 25, 2015

(54) TEXT LINE FRAGMENTS FOR TEXT LINE ANALYSIS

(71) Applicant: CANON KABUSHIKI KAISHA

(72) Inventor: Michael John Blennerhassett, Chippendale (AU)

(21) Appl. No.: 14/572,637

(22) Filed: Dec. 16, 2014

(30) Foreign Application Priority Data
Dec. 20, 2013 (AU) 2013273778

(51) Int. Cl. G06F 17/22; G06F 17/24

(52) U.S. Cl. CPC G06F 17/2264; G06F 17/243

(57) ABSTRACT

A method of determining a local text line flow from an image of a document is disclosed. The method receives a plurality of text connected components from the image and forms text line fragments of the text connected components based on interconnection features between neighbouring text connected components of the plurality of text connected components. The text line fragments have a predetermined maximum aspect ratio. The method then determines the local text line flow for the document based on a properties of the text line fragments.

### REFERENCE TO RELATED PATENT APPLICATION(S)

This application claims the benefit under 35 U.S.C. §119 of the filing date of Australian Patent Application No. 2013273778, filed Dec. 20, 2013, hereby incorporated by reference in its entirety as if fully set forth herein.

### TECHNICAL FIELD

The current invention relates to image processing and, in particular, to processing an input image to detect text lines.

### BACKGROUND

The proliferation of imaging technology combined with ever increasing computational processing power has led to many advances in the area of document analysis, including the detection of lines of text. Many images of documents are however distorted by perspective and warp, for example if the document is a book with a large spine being copied with a photocopier, or the document is captured by a camera. The presence of perspective and warp complicates the problem of detecting text lines in the document image.

Some previous methods use a nearest neighbour graph for Connected Components (CCs) detected from the document image. A CC is a group of pixels that are connected by some common property, typically by having the same colour or which vary in colour from a predetermined seed colour by some predetermined amount. For example, text is often printed as black pixels but these may image as darker shades of grey. The properties of distance and angle for this nearest neighbour graph can be plotted in a histogram and properties of the histogram may be used to decide which distance and angle thresholds to use for merging CCs into text lines. As the histogram is global for the document image, the thresholds decided will not be suitable for detecting text lines with more than small amounts of perspective and warp. Variations on this method include rotating the document image to the dominant text orientation and forming text lines which are mostly horizontal. A vanishing point of the mostly horizontal text lines can then be calculated to correct for perspective. This method does not correct for warp, however.

Other previous methods use a nearest neighbour distance histogram to choose a threshold to merge together only close CCs to form seed candidates. Seed candidates which pass a straightness criterion are extended by merging neighbouring CCs to each end. This method is able to detect text lines with perspective and warp in some circumstances, but fails when seed candidates cannot be found due to CCs not being of similar size, resulting in no seed candidates passing the straightness criterion.

Previous methods for text line extraction also include using active contours, or ‘snakes’ as they are colloquially known in the art. These active contours are attached to the top and bottom of each CC and are extended outward based on the top and bottom of nearby CCs. This method is able to detect text lines with perspective and warp, but requires that a prior orientation is available to determine a guess for ‘top’ and ‘bottom’ for each CC. CCs not being of similar size will also degrade the performance of this method.

### SUMMARY

According to one aspect of the present disclosure, there is provided a method of determining a local text line flow from an image of a document, the method comprising:

receiving a plurality of text connected components from the image;

forming text line fragments of the text connected components based on interconnection features between neighbouring text connected components of the plurality of text connected components, the text line fragments having a predetermined maximum aspect ratio; and

determining the local text line flow for the document based on a properties of the text line fragments.

Preferably each of the text line fragments are formed using text line fragments having an aspect ratio within the predetermined maximum aspect ratio.

Generally the forming comprises at least one of merging text connected components to form a text line fragment, and splitting text line fragments into multiple text line fragments.

More specifically, the forming comprises:

merging text connected components to form text line fragments; and

splitting text line fragments to provide for the text line fragments to have an aspect ratio within the predetermined maximum aspect ratio.

The method may further determine the aspect ratio of a text line fragment using an image moment of the text line fragment. This can be done in a number of ways, including:
determining of the aspect ratio comprises calculating second order image moments using pixels of connected components contained in the text line fragment;
determining of the aspect ratio comprises calculating image moments by summing pixel values weighted by position in the text line fragment.

For example, the zero'th order moment is the sum of the number of a set of pixels formed by one of an area of a connected components or a group of connected components, and the one-zero and the zero-one order image moments are the sum of a set of pixels weighted by x-position and y-position respectively. This approach may further comprise dividing the one-zero and zero-one image moments by the zero'th moment to provide the x-position and y-position respectively for the centroid of a set of pixels. The aspect ratio of a set of pixels can also be calculated using central moments, the central moments being calculated by summing pixels weighted by position which is offset by the centroid.

In another implementation the aspect ratio for a set of pixels can be determined by calculating the smallest rotated rectangle that contains all the pixels of the set, and using a ratio of the width and height of the rotated rectangle as the aspect ratio for the set of pixels.

Alternatively the method may approximate the aspect ratio of a text line fragment by counting the number of contained text connected components.

Preferably the determining of the local text line flow comprises generating a Delaunay triangulation from interconnection features associate with the text line fragments and calculating a curst for points in the triangulation, and using the crust to form text lines from the text line fragments. Typically the forming of text lines comprises associating text line fragments within a distance threshold of a line of the crust. Alternatively the forming of text lines comprises associating text line fragments within an angle threshold of a line of the crust.

According to another aspect of the present disclosure, there is provided a method of determining a local text line flow from an image of a document, the method comprising:

receiving a plurality of text CCs from the image;

forming text line fragments of the text CCs based on interconnection features between neighbouring text CCs of the plurality of text CCs;

forming sub-text line fragments by splitting the formed text line fragments according to an aspect ratio of the formed text line fragments and a comparison of a size of the text line fragment with a size of the text CCs forming the text line fragment; and

determining the local text line flow for the document based on a centre of each of the sub-text line fragments and a direction of an axis of each of the sub-text line fragments.

Other aspects are also disclosed.

### BRIEF DESCRIPTION OF THE DRAWINGS

At least one embodiment of the invention will now be described with reference to the following drawings, in which:

FIG. 1 shows a context diagram for text line detection;

FIG. 2 is a schematic block diagram of a data processing architecture for a method of text line detection according to the present disclosure;

FIG. 3 is a schematic flow diagram illustrating a method of detecting text line fragments as used in the method of FIG. 2;

FIG. 4 is a schematic flow diagram illustrating a method of splitting text line fragments as used in the method of FIG. 3;

FIG. 5 is a schematic flow diagram illustrating another method of detecting text line fragments as used in the method of FIG. 2;

FIG. 6 is a schematic flow diagram illustrating a method of fixing overmerged text line fragments as used in the method of FIG. 2;

FIG. 7 is a schematic flow diagram illustrating a method of detecting text lines as used in the method of FIG. 2;

FIG. 8B shows an example document image input and FIG. 8A a representation of connected components formed from the document image;

FIG. 9A shows a representation of connected components formed from the document image of FIG. 8B and FIG. 9B shows a Delaunay triangulation of the centrepoints of the ellipse representing the connected components;

FIG. 10A shows a representation of text line fragments formed from the connected components shown in FIG. 9A and FIG. 10B shows a Delaunay triangulation of points along the principle axis for each text line fragment;

FIGS. 11A and 11B show the crust for the Delaunay triangulations shown in FIGS. 9B and 10B respectively;

FIG. 12B shows an example document image input and FIG. 12A shows a representation of connected components formed from the document image;

FIGS. 13A and 13B show representations of text line fragments formed from the connected components shown in FIG. 12A constructed both with and without a maximum aspect ratio, respectively;

FIGS. 14A and 14B show the crust for the Delaunay triangulations of points along the principle axis for the text line fragments shown in FIGS. 13A and 13B respectively;

FIG. 15 shows an example text line fragment and contained CCs;

FIG. 16 shows a text line fragment and points which are added to a triangulation; and

FIGS. 17A and 17B form a schematic block diagram of a general purpose computer system upon which arrangements described can be practiced.

### DETAILED DESCRIPTION INCLUDING BEST MODE

Context

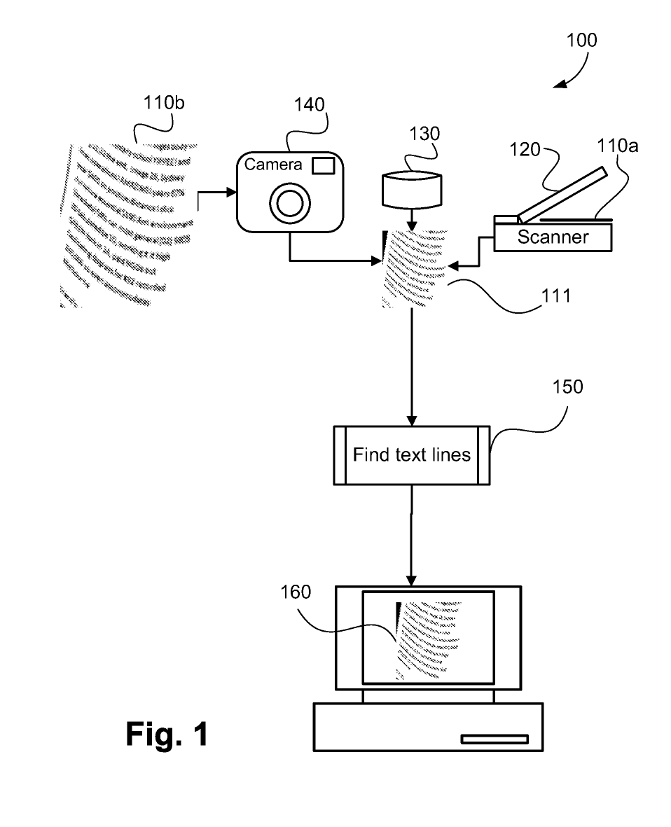

FIG. 1 depicts a text line detection system 100 for detecting curved and warped text lines in a document image. The text line detection system 100 processes an image 111 of an input document to produce an electronic document 160 that can be further processed, for example by de-warping the text lines, and/or performing optical character recognition (OCR), and/or be edited in a word processing application.

The image 111 may be produced by any of a number of sources, such as by a scanner 120 scanning a hardcopy document 110a, by retrieval from a data storage system 130 such as a hard disk having a database of images stored on the hard disk, or by digital photography of a hardcopy document 110b using a camera 140. These are merely examples of how the image 111 might be provided. As another example, the image 111 could be created by a software application as an extension of printing functionality of the software application.

The input image 111 is processed to find text lines 150. One way of finding text lines is to use a process where Connected Components (CCs) are merged together to form text lines. The found text lines can then be shown to the user 160 using a display device, and further processed as described above.

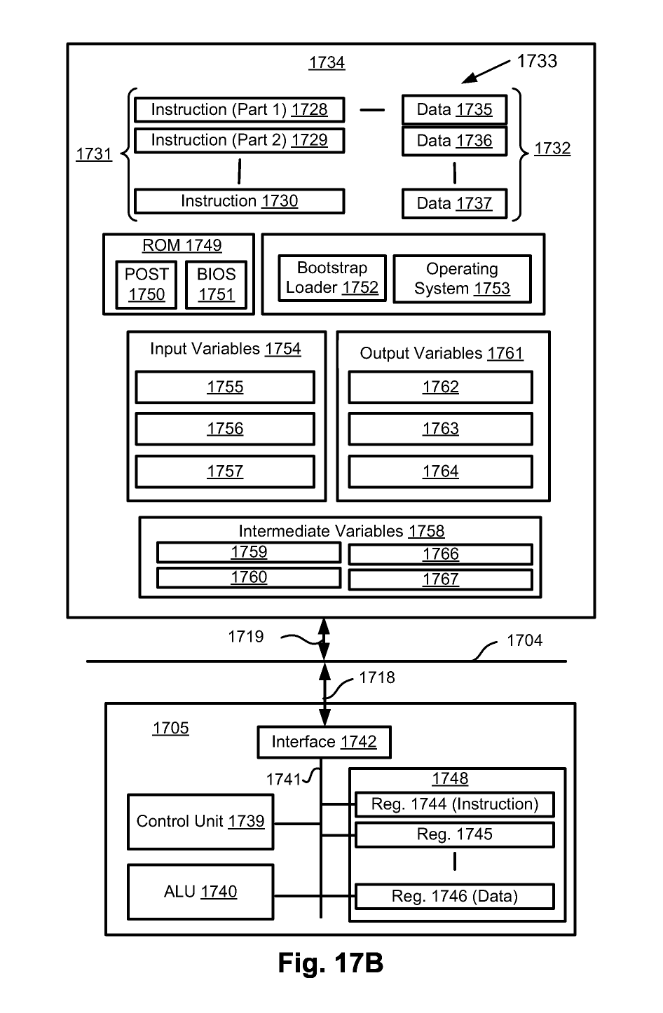

The process for finding text lines 150 can be carried out on a computer processing arrangement configured to examine the image components to extract or at least delineate the text lines from other image content. FIGS. 17A and 17B depict a general-purpose computer system 1700, upon which the various arrangements described can be practiced.

As seen in FIG. 17A, the computer system 1700 includes: a computer module 1701; input devices such as a keyboard 1702, a mouse pointer device 1703, a scanner 1726, a camera 1727, and a microphone 1780; and output devices including a printer 1715, a display device 1714 and loudspeakers 1717. An external Modulator-Demodulator (Modem) transceiver device 1716 may be used by the computer module 1701 for communicating to and from a communications network 1720 via a connection 1721. The communications network 1720 may be a wide-area network (WAN), such as the Internet, a cellular telecommunications network, or a private WAN. Where the connection 1721 is a telephone line, the modem 1716 may be a traditional “dial-up” modem. Alternatively, where the connection 1721 is a high capacity (e.g., cable) connection, the modem 1716 may be a broadband modem. A wireless modem may also be used for wireless connection to the communications network 1720.

The computer module 1701 typically includes at least one processor unit 1705, and a memory unit 1706. For example, the memory unit 1706 may have semiconductor random access memory (RAM) and semiconductor read only memory (ROM). The computer module 1701 also includes an number of input/output (I/O) interfaces including: an audio-video interface 1707 that couples to the video display 1714, loudspeakers 1717 and microphone 1780; an I/O interface 1713 that couples to the keyboard 1702, mouse 1703, scanner 1726, camera 1727 and optionally a joystick or other human interface device (not illustrated); and an interface 1708 for the external modem 1716 and printer 1715. In some implementations, the modem 1716 may be incorporated within the computer module 1701, for example within the interface 1708. The computer module 1701 also has a local network interface 1711, which permits coupling of the computer system 1700 via a connection 1723 to a local-area communications network 1722, known as a Local Area Network (LAN). As illustrated in FIG. 17A, the local communications network 1722 may also couple to the wide network 1720 via a connection 1724, which would typically include a so-called “firewall” device or device of similar functionality. The local network interface 1711 may comprise an Ethernet circuit card, a Bluetooth™ wireless arrangement or an IEEE 802.11 wireless arrangement; however, numerous other types of interfaces may be practiced for the interface 1711.

The I/O interfaces 1708 and 1713 may afford either or both of serial and parallel connectivity, the former typically being implemented according to the Universal Serial Bus (USB) standards and having corresponding USB connectors (not illustrated). Storage devices 1709 are provided and typically include a hard disk drive (HDD) 1710. Other storage devices such as a floppy disk drive and a magnetic tape drive (not illustrated) may also be used. An optical disk drive 1712 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the system 1700.

The components 1705 to 1713 of the computer module 1701 typically communicate via an interconnected bus 1704 and in a manner that results in a conventional mode of operation of the computer system 1700 known to those in the relevant art. For example, the processor 1705 is coupled to the system bus 1704 using a connection 1718. Likewise, the memory 1706 and optical disk drive 1712 are coupled to the system bus 1704 by connections 1719. Examples of computers on which the described arrangements can be practiced include IBM-PC's and compatibles, Sun Sparcstations, Apple Mac or a like computer systems.

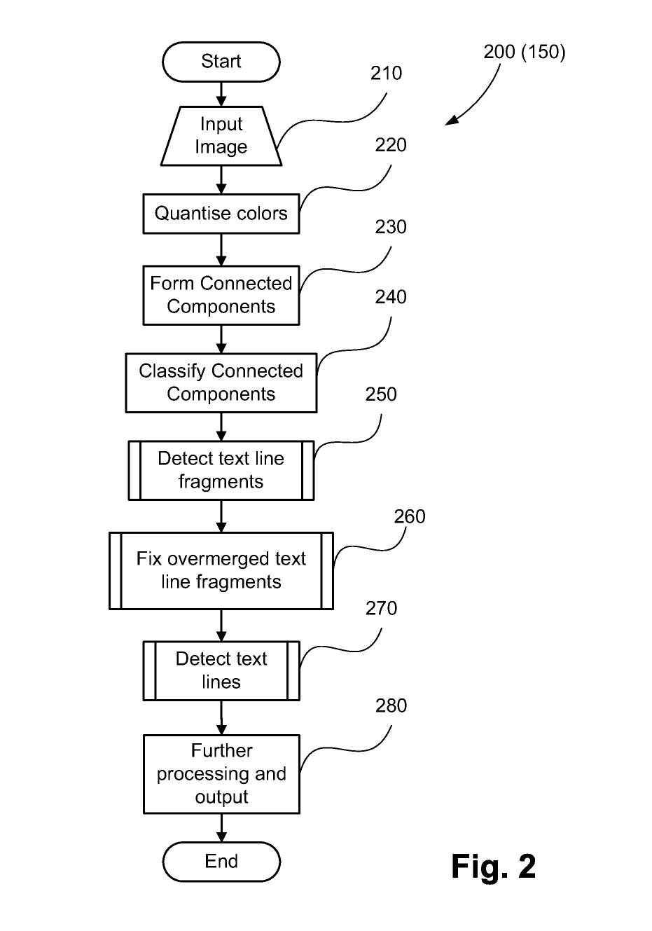

The methods of text line detection may be implemented using the computer system 1700 wherein the processes of FIGS. 2 to 16, to be described, may be implemented as one or more software application programs 1733 executable within the computer system 1700. In particular, the steps of the method of text line detection are effected by instructions 1731 (see FIG. 17B) in the software 1733 that are carried out within the computer system 1700. The software instructions 1731 may be formed as one or more code modules, each for performing one or more particular tasks. The software may also be divided into two separate parts, in which a first part and the corresponding code modules performs the detection methods and a second part and the corresponding code modules manage a user interface between the first part and the user.

The software may be stored in a computer readable medium, including the storage devices described below, for example. The software is loaded into the computer system 1700 from the computer readable medium, and then executed by the computer system 1700. A computer readable medium having such software or computer program recorded on the computer readable medium is a computer program product. The use of the computer program product in the computer system 1700 preferably effects an advantageous apparatus for text line detection.

The software 1733 is typically stored in the HDD 1710 or the memory 1706. The software is loaded into the computer system 1700 from a computer readable medium, and executed by the computer system 1700. Thus, for example, the software 1733 may be stored on an optically readable disk storage medium (e.g., CD-ROM) 1725 that is read by the optical disk drive 1712. A computer readable medium having such software or computer program recorded on it is a computer program product. The use of the computer program product in the computer system 1700 preferably effects an apparatus for text line detection.

In some instances, the application programs 1733 may be supplied to the user encoded on one or more CD-ROMs 1725 and read via the corresponding drive 1712, or alternatively may be read by the user from the networks 1720 or 1722. Still further, the software can also be loaded into the computer system 1700 from other computer readable media. Computer readable storage media refers to any non-transitory tangible storage medium that provides recorded instructions and/or data to the computer system 1700 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 1701. Examples of transitory or non-tangible computer readable transmission media that may also participate in the provision of software, application programs, instructions and/or data to the computer module 1701 include radio or infra-red transmission channels as well as a network connection to another computer or networked device, and the Internet or Intranets including e-mail transmissions and information recorded on Websites and the like.

The second part of the application programs 1733 and the corresponding code modules mentioned above may be executed to implement one or more graphical user interfaces (GUIs) to be rendered or otherwise represented upon the display 1714. Through manipulation of typically the keyboard 1702 and the mouse 1703, a user of the computer system 1700 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1717 and user voice commands input via the microphone 1780.

FIG. 17B is a detailed schematic block diagram of the processor 1705 and a “memory” 1734. The memory 1734 represents a logical aggregation of all the memory modules (including the HDD 1709 and semiconductor memory 1706) that can be accessed by the computer module 1701 in FIG. 17A.

When the computer module 1701 is initially powered up, a power-on self-test (POST) program 1750 executes. The POST program 1750 is typically stored in a ROM 1749 of the semiconductor memory 1706 of FIG. 17A. A hardware device such as the ROM 1749 storing software is sometimes referred to as firmware. The POST program 1750 examines hardware within the computer module 1701 to ensure proper functioning and typically checks the processor 1705, the memory 1734 (1709, 1706), and a basic input-output systems software (BIOS) module 1751, also typically stored in the ROM 1749, for correct operation. Once the POST program 1750 has run successfully, the BIOS 1751 activates the hard disk drive 1710 of FIG. 17A. Activation of the hard disk drive 1710 causes a bootstrap loader program 1752 that is resident on the hard disk drive 1710 to execute via the processor 1705. This loads an operating system 1753 into the RAM memory 1706, upon which the operating system 1753 commences operation. The operating system 1753 is a system level application, executable by the processor 1705, to fulfil various high level functions, including processor management, memory management, device management, storage management, software application interface, and generic user interface.

The operating system 1753 manages the memory 1734 (1709, 1706) to ensure that each process or application running on the computer module 1701 has sufficient memory in which to execute without colliding with memory allocated to another process. Furthermore, the different types of memory available in the system 1700 of FIG. 17A must be used properly so that each process can run effectively. Accordingly, the aggregated memory 1734 is not intended to illustrate how particular segments of memory are allocated (unless otherwise stated), but rather to provide a general view of the memory accessible by the computer system 1700 and how such is used.

As shown in FIG. 17B, the processor 1705 includes a number of functional modules including a control unit 1739, an arithmetic logic unit (ALU) 1740, and a local or internal memory 1748, sometimes called a cache memory. The cache memory 1748 typically includes a number of storage registers 1744-1746 in a register section. One or more internal busses 1741 functionally interconnect these functional modules. The processor 1705 typically also has one or more interfaces 1742 for communicating with external devices via the system bus 1704, using a connection 1718. The memory 1734 is coupled to the bus 1704 using a connection 1719.

The application program 1733 includes a sequence of instructions 1731 that may include conditional branch and loop instructions. The program 1733 may also include data 1732 which is used in execution of the program 1733. The instructions 1731 and the data 1732 are stored in memory locations 1728, 1729, 1730 and 1735, 1736, 1737, respectively. Depending upon the relative size of the instructions 1731 and the memory locations 1728-1730, a particular instruction may be stored in a single memory location as depicted by the instruction shown in the memory location 1730. Alternately, an instruction may be segmented into a number of parts each of which is stored in a separate memory location, as depicted by the instruction segments shown in the memory locations 1728 and 1729.

In general, the processor 1705 is given a set of instructions which are executed therein. The processor 1705 waits for a subsequent input, to which the processor 1705 reacts to by executing another set of instructions. Each input may be provided from one or more of a number of sources, including data generated by one or more of the input devices 1702, 1703, data received from an external source across one of the networks 1720, 1702, data retrieved from one of the storage devices 1706, 1709 or data retrieved from a storage medium 1725 inserted into the corresponding reader 1712, all depicted in FIG. 17A. The execution of a set of the instructions may in some cases result in output of data. Execution may also involve storing data or variables to the memory 1734.

The disclosed text line detection arrangements use input variables 1754, which are stored in the memory 1734 in corresponding memory locations 1755, 1756, 1757. The arrangements produce output variables 1761, which are stored in the memory 1734 in corresponding memory locations 1762, 1763, 1764. Intermediate variables 1758 may be stored in memory locations 1759, 1760, 1766 and 1767.

Referring to the processor 1705 of FIG. 17B, the registers 1744, 1745, 1746, the arithmetic logic unit (ALU) 1740, and the control unit 1739 work together to perform sequences of micro-operations needed to perform “fetch, decode, and execute” cycles for every instruction in the instruction set making up the program 1733. Each fetch, decode, and execute cycle comprises:

(i) a fetch operation, which fetches or reads an instruction 1731 from a memory location 1728, 1729, 1730;

(ii) a decode operation in which the control unit 1739 determines which instruction has been fetched; and

(iii) an execute operation in which the control unit 1739 and/or the ALU 1740 execute the instruction.

Thereafter, a further fetch, decode, and execute cycle for the next instruction may be executed. Similarly, a store cycle may be performed by which the control unit 1739 stores or writes a value to a memory location 1732.

Each step or sub-process in the processes of FIGS. 2 to 16 is associated with one or more segments of the program 1733 and is performed by the register section 1744, 1745, 1747, the ALU 1740, and the control unit 1739 in the processor 1705 working together to perform the fetch, decode, and execute cycles for every instruction in the instruction set for the noted segments of the program 1733.

The methods of text line detection may alternatively be implemented in dedicated hardware such as one or more integrated circuits performing the functions or sub functions to be described. Such dedicated hardware may include graphic processors, digital signal processors, or one or more microprocessors and associated memories. Such implementations may be particularly suit to implementations where the text line detection process 150 is integrally formed within the scanner 120, or other similar device, including a photocopier or multi-function device (not illustrated), each of which includes a scanning function.

Overview

FIG. 2 illustrates an overview process 200 for detecting text lines in further detail than described at process 150 of FIG. 1. The process 200 is preferably implemented as a software application for example stored on the HDD 1710 and executable by the processor 1705 in concert with the memory 1706. An input image 210 is received from an imaging device such as the hand-held camera 1727 or the scanner 1726 as described at image input step 111 of FIG. 1. The image 210 may be stored to either or both of the memory 1706 and HDD 1710. Next the processor 1705 applies colour quantisation 220 to the image 210, for example by threshold binarisation to form a quantised image in the memory 1706. Other colour quantisations may be used, including quantisation to a fixed number of colours, or a variable number of colours based on a colour distance metric. In a next step 230, the processor 1705 processes the quantised image to form Connected Components (CCs) by merging together adjacent pixels with the same quantised colour. Connected Components are then classified at step 240 by the processor 1705 to produce a list of text connected components (text CCs). An example classifier is to classify all CCs in the image as text CCs. This may be appropriate where the image contains, for example, simply black text on a plain white background. However it is advantageous and often necessary to classify some CCs as non-text such as the document image background, line art and pictures. An example classifier can use CC size features to classify some CCs as non-text. Following step 240, all steps described operate only upon text CCs. Accordingly, any reference simply to CCs in such steps should be construed as a reference to text CCs, unless otherwise expressly noted.

A process 250 then is performed by the processor 1705 to detect text line fragments by merging together text CCs to form text line fragments that may range in size from the whole text line to a sub-character fragment. A process 260 then operates to split apart text line fragments which are overmerged as a result of step 250 such that they contain text CCs from separate lines. From these text line fragments, complete text lines based on local text line flow, are detected by a process 270. One method to detect individual text lines from text line fragments is to merge together endpoints of text line fragments if the distance between the endpoints and the difference in angle is within some set of corresponding thresholds. A range of suitable methods to detect text lines from text line fragments can be found by considering the problem as a dashed-line detection problem. Text line fragments can be represented as objects with a thickness and length and angle, and dashed line detection methods applied, although the method may have to be modified to better suit the particular problem.

At step 280 the text lines detected by process 270 are further processed by the processor 1705, for example for display to the user on the display device 1714 or for use in a document image de-warping step as described at step 160 of FIG. 1.

CCs in general and text CCs in particular are formed as groups of pixels possessing like properties, and therefore may take particularly arbitrary shapes (e.g. font characters). In a processing environment, it is convenient however to represent each CC as a simple ellipse, having a height and width, forming an aspect ratio, and sometimes qualified by an angle of inclination to some reference axis, generally defined by axes of the ellipse. The ellipses are centred over the midpoint of the bounding box of the pixels of the CC. In this fashion, interrelationships between different CCs can be readily established and compared without need to consider the differences between individual complex CC shapes. In the processing to be described, particularly that following step 240, CCs are considered as represented by ellipses.

First Implementation

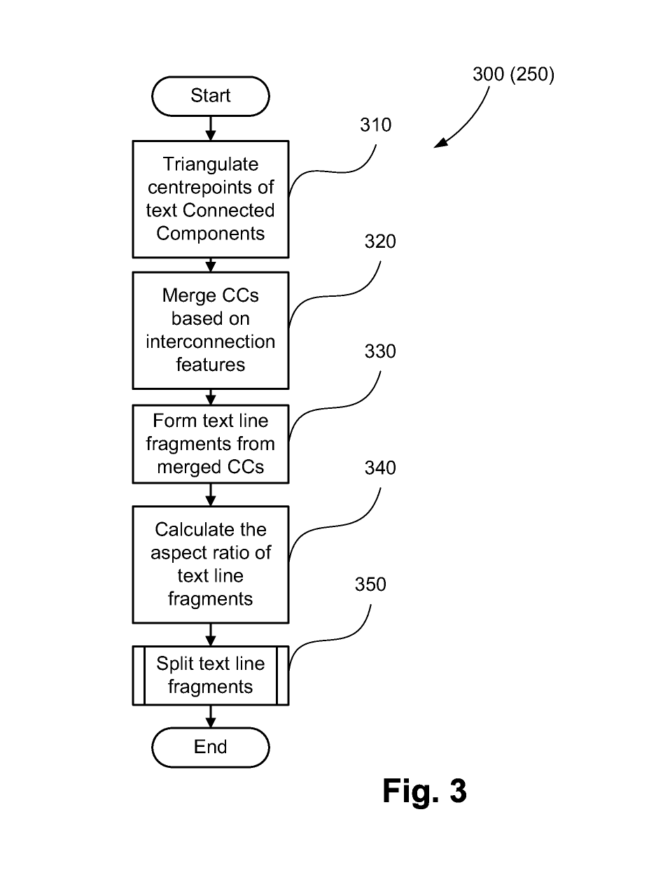

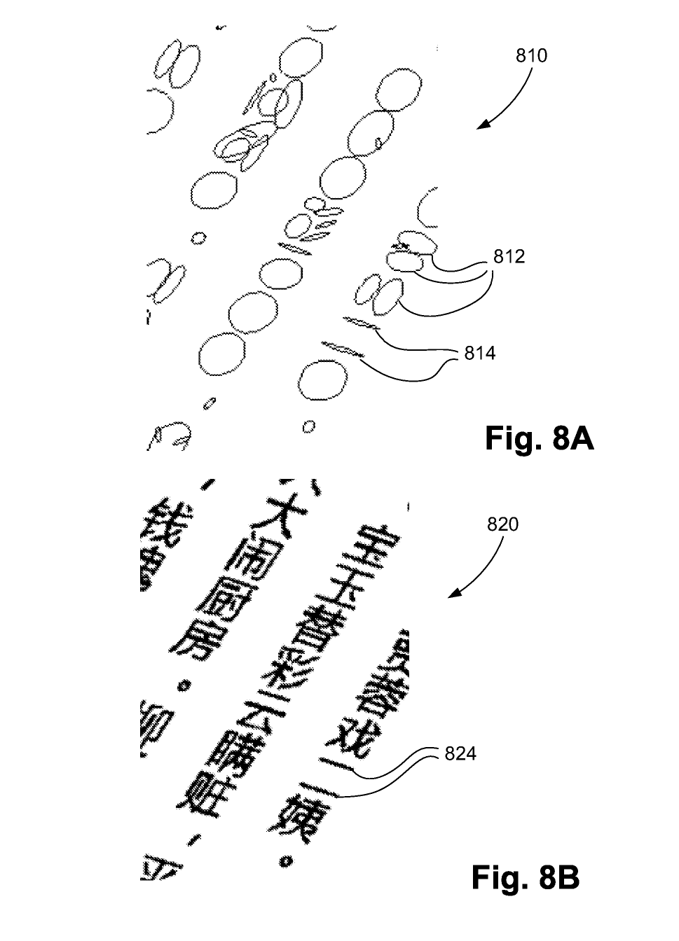

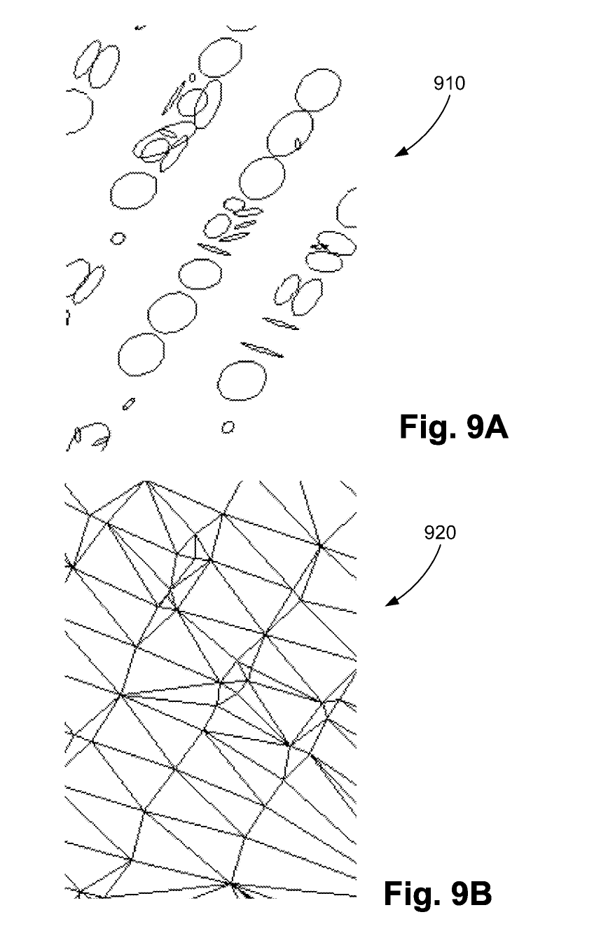

FIG. 3 illustrates an exemplary method 300 which operates to detect text line fragments as shown by process 250. At an initial triangulation step 310 the centrepoints of ellipses for all text classified CCs received from CC classification step 240 are triangulated to form edges between the ellipse centrepoints. A suitable point set triangulation is the Delaunay triangulation, which has the property that the circumcircle for each triangle (made up of three edges) contains no other point in the triangulation. Other point set triangulations or nearest neighbour methods can also be used. An example input document image is shown in FIG. 8B having input pixels 820 formed as Kanji characters, clearly of complex and highly varying shape. The corresponding CC representation 810 is shown in FIG. 8A where individual CCs are represented by ellipses 812. In this example it will be appreciated that the Kanji characters 824 of FIG. 8B are represented by ellipses 814 in FIG. 8A. The CCs in FIG. 8A, and others in this patent specification, are represented by ellipses with the major and minor axes corresponding to the second order central moments of the CC and the angle of the ellipse corresponding to the principle axis for the CC. FIG. 9A shows a further representation 920 of the CCs of FIG. 8A and the corresponding Delaunay triangulation 920 is seen in FIG. 9B. The image 920 shows the Delaunay triangulation of the centrepoint of the ellipses representing the CCs.

At step 320 neighbouring text CCs are merged together based on interconnection features therebetween of the corresponding ellipses and the Delaunay triangulation. Many such features can be developed and used. Some simple examples of such interconnection features include:
the distance between pairs of points, such as points in the triangulation,
the relative angle between pairs of points in the triangulation and other edges, such as edges forming axes of CCs or triangulation edges,
the relative distance between pairs of points and other connected points, and
the relative sizes of the text CCs connected by an edge in the triangulation to mention but a few. The decision to merge together a pair of text CCs, or not, can be based on heuristics and the interconnection features, or a machine learned classifier such as a Support Vector Machine (SVM).

At step 330, neighbouring text CCs which were merged together at merging step 320 are formed into text line fragments. A text line fragment can contain one or more text CCs, and can represent any portion of a text line, from a sub-character to a whole text line. Text CCs which were not merged with any other text CC at merging step 320 can nevertheless form a single CC text line fragment.

At step 340 the aspect ratio of all the text line fragments is calculated. One way to determine the aspect ratio of a text line fragment to calculate the second order image moments using the pixels of all CCs contained in a text line fragment. Image moments can be calculated by summing pixel values weighted by position in the text line fragment. The zero'th order moment is the sum of the number of a set of pixels, which is the area of a CC or group of CCs. The one-zero and the zero-one order image moments are the sum of a set of pixels weighted by x-position and y-position respectively. Dividing the one-zero and zero-one image moments by the zero'th moment gives the x-position and y-position respectively for the centroid, or centre of mass, of a set of pixels. The image moments that are useful for calculating the aspect ratio of a set of pixels are the central moments, which are calculated by summing pixels weighted by position which is offset by the centroid. The covariance matrix of a set of pixels can be constructed by the two-zero central moment and the zero-two central moment on the diagonal, and the one-one central moment on both off-diagonal positions. All four elements of the matrix are divided by the zero'th image moment to give the covariance matrix. The eigenvectors of the covariance matrix correspond to the major (long) and minor (short) axes of the set of pixels, and the eigenvalues of the covariance matrix are proportional to the squared length of the eigenvector axes. One way to calculate the principle axis of a set of pixels is to take the angle of the eigenvector associated with larger of the eigenvalues. The aspect ratio of a set of pixels can be calculated by taking the square root of the larger eigenvalue divided by the square root of the smaller eigenvalue. If the eigenvalues are equal then the aspect ratio is one.

Another way to calculate the aspect ratio for a set of pixels is to calculate the smallest rotated rectangle that contains all the pixels, and use the ratio of the width and height of the rotated rectangle as the aspect ratio for the set of pixels. Another way to approximate the aspect ratio of a text line fragment is to count the number of contained CCs, since many text CCs have similar size.

Once the aspect ratio for all of the text line fragments is calculated, then the text line fragments are split by process 350 based on the aspect ratio of the text line fragment and a predetermined maximum threshold. After the text line fragments have been split, the detection of text line fragments process described at step 250 is completed and processing flow proceeds to fixing overmerged text line fragments at step 260.

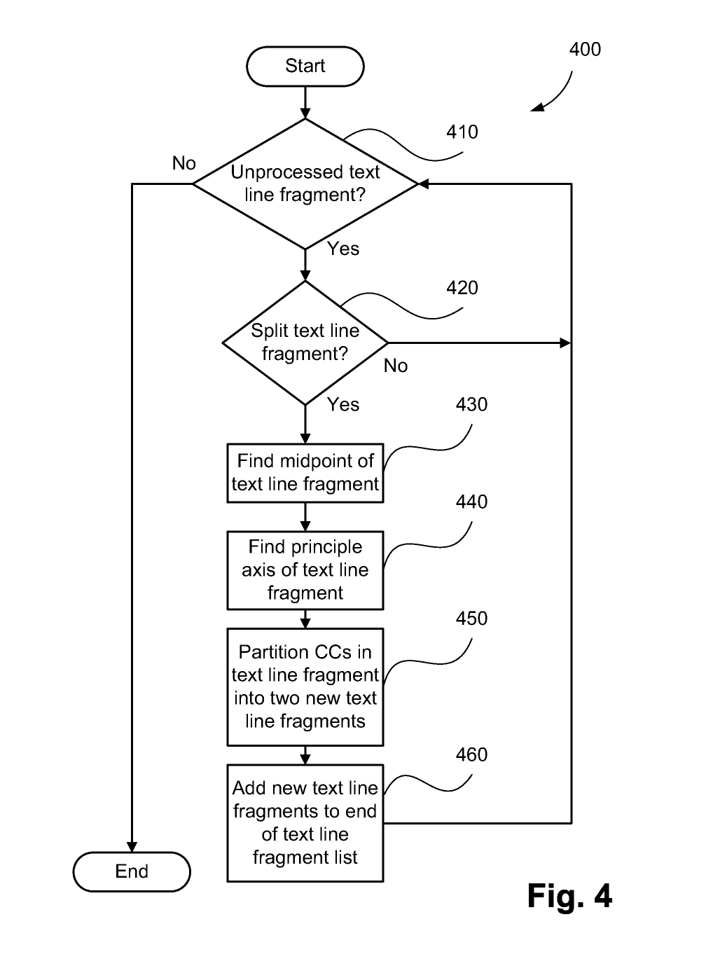

FIG. 4 illustrates one example of a text line fragment splitting process 400 that may be used to perform the splitting step 350. In calling the processes 400, a list is created by the processor 1705, for example in the memory 1706, to hold text line fragments as they are processed in turn. At step 410, the next unprocessed text line fragment is selected from the list. If there are no more unprocessed text line fragments, then processing control for the process ends 400, and processing control returns to step 260 as described above. If there is an unprocessed text line fragment selected, then that text line fragment is tested at step 420 to determine whether it should be split. The test checks whether the aspect ratio of the text line fragment is below a maximum predetermined threshold. This predetermined maximum threshold can be fixed at some given number, for example five, meaning that no text line fragments will be more than five times longer than they are thick, or may be determined by any prior knowledge of scale and warp for the document image. Where the aspect ratio of a text line fragment was approximated by the contained CC count, then the threshold is more easily expressed as a maximum CC count for text line fragments. If the aspect ratio is being approximated by the count of the number of CCs in the text line fragment, then the threshold is a maximum CC count. If the text line fragment is below the maximum aspect ratio threshold, then processing control returns to step 410 where a new unprocessed text line fragment is selected.

Where the text line fragment has an aspect ratio above a predetermined maximum, then processing control goes to step 430 where a midpoint of the text line fragment is found by the processor 1705. This midpoint of the text line fragment may be the centroid calculated from the image moments, or the centre of a bounding box for a minimum rotated rectangle containing the pixels of the contained CCs for the text line fragment. The midpoint may also be calculated by averaging the centre of ellipses for the contained CCs.

The principle axis for the text line fragment is calculated by the processor 1705 at step 440. The principle axis can be calculated from the second order central moments, or as the angle of the longer axis of the minimum rotated rectangle containing the pixels of the contained CCs for the text line fragment, or as the regression line for the ellipse centrepoint for the contained CCs for the text line fragments. The axis orthogonal (rotated 90 degrees) to the principle axis determined at step 440 at the midpoint of the text line fragment previously calculated at step 430 are used in a partitioning step 450 to partition the CCs of the text line fragment into two new text line fragments.

One way to partition the text line fragment is to create a new text line fragment for all the CCs with an ellipse centre to the left of the line through the text line fragment midpoint at an angle orthogonal to the principle axis, and a new text line fragment for all the CCs with an ellipse centre to the right of the line through the text line fragment midpoint at an angle orthogonal to the principle axis. If one of the new text line fragments created at partitioning step 450 has no contained CCs, then there are different options to split the text line fragment. One option is to add the non-empty text line fragment to the text line fragment list, mark the non-empty text line fragment as processed and return processing control to the text line fragment selecting step 410. Another option is to split the contained CCs of the text line fragment through the line through the text line fragment midpoint at an angle orthogonal to the principle axis. For any CCs split, a new text line fragment for CCs or part CCs of the left of the dividing line, and a new text line fragment is created for CCs or part CCs on the right of the dividing line.

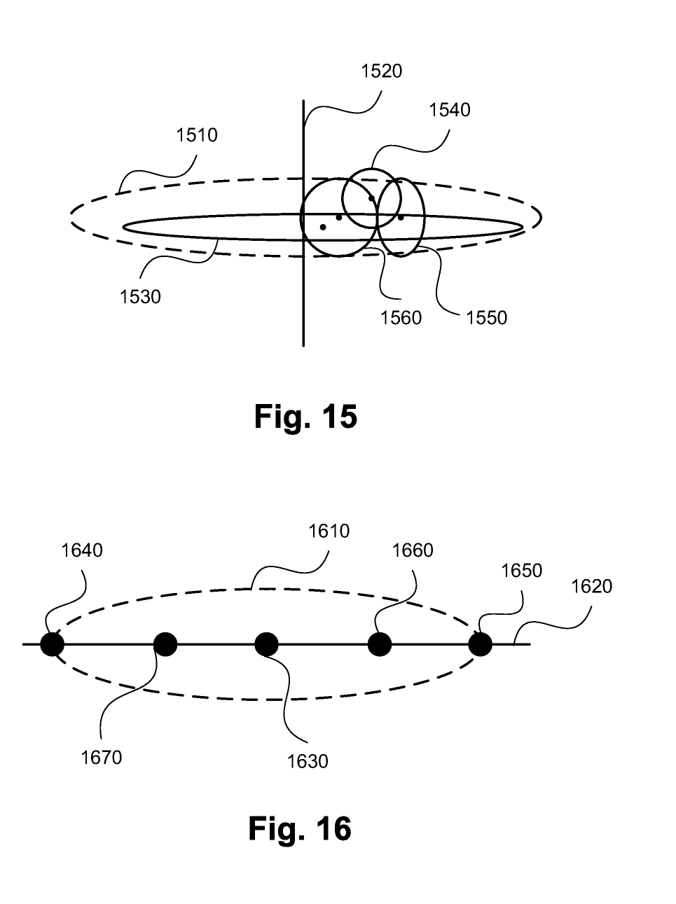

An example text line fragment is shown in FIG. 15. The length, width and principle axis of the text line fragment are represented by a dashed ellipse 1510. The dividing line through the midpoint of the text line fragment 1510 at an angle orthogonal to the principle axis is shown as line 1520. Contained CCs and their midpoints of the example text line fragment 1510 are represented as ellipses 1530, 1540, 1550 and 1560. In the case of text line fragment 1510, all of the midpoints of the contained CCs are to the right of the dividing line 1520. To successfully split the text line fragment 1510, the contained CCs 1530 and 1560 also need to be split, with the portions of CCs 1530 and 1560 to the left of the split line 1520 being added to a new text line fragment.

In cases where two new non-empty text line fragments are created, both new text line fragments are marked as unprocessed and placed on the end of the text line fragment list at step 460. Processing control then returns to text line fragment selecting step 410. As the two new text line fragments created at step 450 are marked as unprocessed, they will be selected for processing at text line fragment selecting step 410. Therefore, when the text line fragment splitting process 400 finishes at finishing step 410, many text line fragments will have an aspect ratio less than the predetermined maximum if CCs themselves are not split at partitioning step 450. In the case where CCs themselves are split, all text line fragments will have an aspect ratio less than the predetermined maximum.

Second Implementation

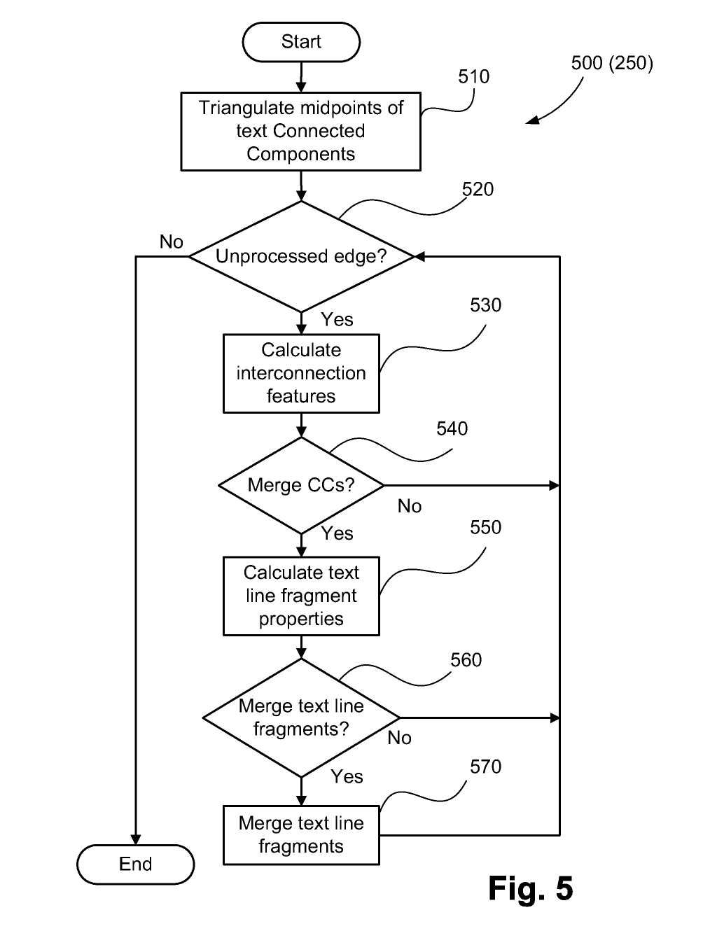

FIG. 5 illustrates an alternate exemplary method 500, for detecting text line fragments useful for the process 250 from FIG. 2. At an initial triangulation step 510 the centrepoints of ellipses for all text classified CCs received from CC classification step 240 are triangulated to form edges between the centrepoints. This triangulation step 510 is the same step as triangulation step 310 shown in FIG. 3. The edges from the triangulation step 510 are selected in turn by edge selection step 520. If there are no more unprocessed edges, then the detection of text line fragments ends and processing control returns to step 260 as described above. Otherwise processing control goes to calculating step 530 where interconnection features are calculated. These interconnection features are the same features as calculated by merging step 320 from FIG. 3. At testing step 540 the interconnection features calculated by step 530 are used to decide whether to merge the two CCs at the edge endpoints or not. If the edge does not pass the testing step 540 to merge, then processing control returns to edge selection step 520. Otherwise, the properties of the edge endpoint CCs containing text line fragments are calculated at step 550. If an edge endpoint CC has no containing text line fragment, then the edge endpoint CC's containing text line fragment is created as a text line fragment with one contained CC. As part of the properties calculated by step 550, the aspect ratio of the text line fragments is calculated in the same way as described by aspect ratio calculation step 340 of FIG. 3. At decision step 560, a decision is made as to whether to merge the two text line fragments containing the edge endpoint CCs. If the combined aspect ratio of the edge endpoint CC's containing text line fragments is greater than a predetermined maximum threshold, then the text line fragments are not merged and processing control returns to edge selection step 520. If the decision from step 560 is to merge the edge endpoint CC's containing text line fragments, then the two text line fragment are merged at step 570. Process control then returns to edge selection step 520. After text line fragment creation process 500 is completed, many text line fragments will have an aspect ratio less than the predetermined maximum threshold.

Third Implementation

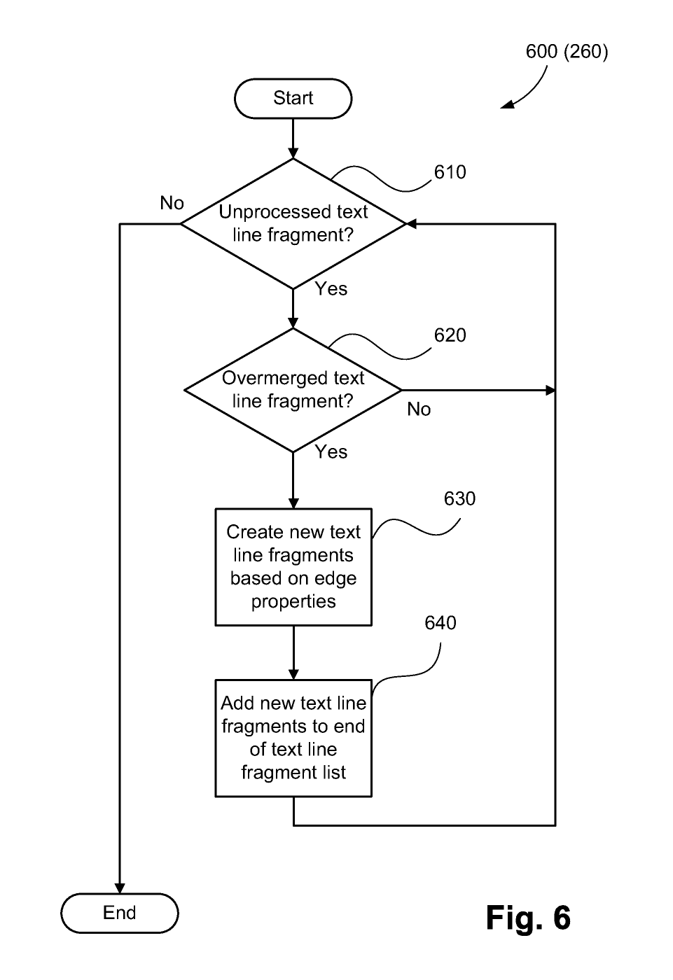

FIG. 6 illustrates an exemplary method 600, which fixes overmerged text line fragments useful to implement the process 260 of FIG. 2. As previously described, a list can be created to hold text line fragments and they are processed in turn. At step 610, the next unprocessed text line fragment is selected from the list. If there are no more unprocessed text line fragments, then the process 600 ends, and processing control goes to text line detection process 270 as described above. If there is an unprocessed text line fragment selected, then that text line fragment is tested at step 620 to determine whether it should be split. The decision to split is to try to split overmerged text line fragments. Overmerged text line fragments are text line fragments which contain CCs from more than one text line. Some properties useful to make the decision whether to split a text line fragment include the ratio of contained CC sizes to the size of the text line fragment. Specifically sub-text line fragments may be formed by splitting the text line fragments according to an aspect ratio of the text line fragments and a comparison of a size of the text line fragment with a size of the text CCs forming the text line fragment. The decision to split a text line fragment determined at step 620 can be made using the calculated properties of the text line fragment and heuristics or a machine learned classifier such as a Support Vector Machine (SVM). If the decision is made not to split the text line fragment, then processing control returns to step 610 where a new unprocessed text line fragment is selected. If the decision is made to split the text line fragment, then processing control goes to step 630 where new text line fragments are created from the contained CCs of the current text line fragment.

One way to create new text line fragments at step 630 is to use the same interconnection features and merging decisions as from CC merging step 320 from FIG. 3, with the exception that a selected edge between a pair of CCs in the text line fragment is set to not merge. The selected edge set to not merge can be chosen by using heuristics based on the current text line fragment, or an SVM classifier, or by choosing every edge one at a time in the text line fragment in turn. The CCs from the current text line fragment can then be merged together, and two new text line fragments may be created. If two new text line fragments are created and they both pass the overmerged text line fragment test 620 with a decision not to split, then these two new text line fragments can be used as the new text line fragments for step 630.

Another method to create new text line fragments from the CCs of the current text line fragment at step 630 is to merge the CCs into text line fragments based on interconnection features. These interconnection features may be different to the interconnection features used in CC merging step 320, and the method used for the merging decision is different so as to create new text line fragments that do not contain CCs from different text lines. If heuristics are used for the merging decision, then they can be more strict than those previously used in CC merging step 320. If a machine learned classifier is used, then different training examples can be provided to make the decision less likely to create text lines fragments that contain CCs from different text lines. Merging CCs based on interconnection features may create one or more new text line fragments, which can be used as the new text line fragments for step 630.

At step 640 the new text line fragments created at step 630 are added to the end of the text line fragment list and marked as unprocessed. The new text line fragments are marked as unprocessed so that the new text line fragments will be tested at overmerged text line fragment testing step 620. Step 640 can also further split the new text line fragments so that they have an aspect ratio of less than a predetermined maximum, by using the midpoint finding step 430, the principle axis finding step 440 and the partitioning step 450 described above with reference to FIG. 4. Note that care has to be taken to avoid infinite loops, so that if a single text line fragment is created at new text line fragment creation step 630, it should not be marked as unprocessed. After all text line fragments have been processed by process 600, process control returns to text line detection process 270 from FIG. 2.

Forming Text Lines

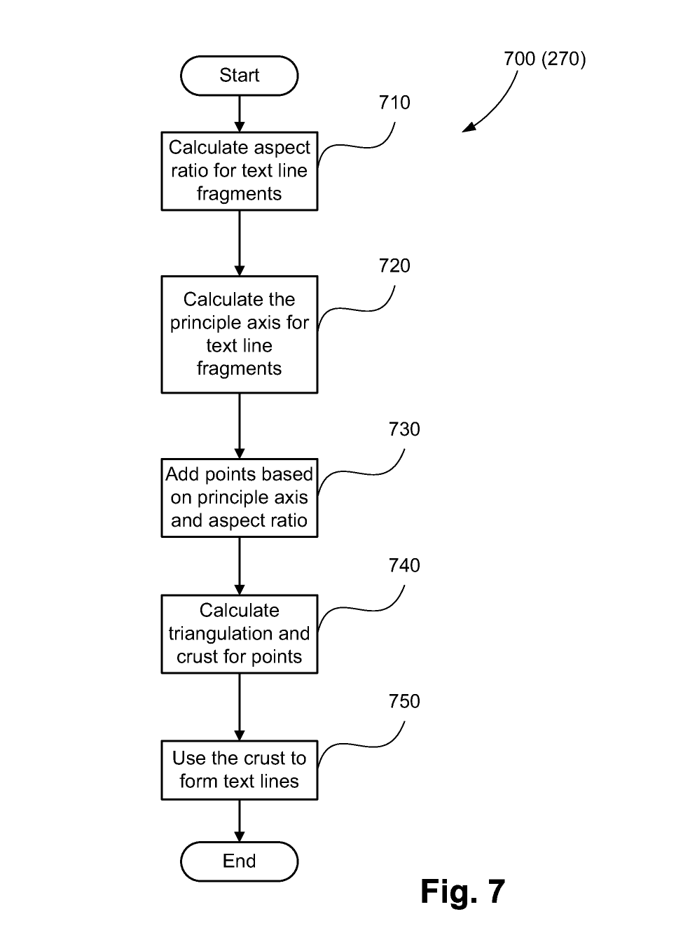

FIG. 7 illustrates an exemplary method of detecting text lines 700 from text line fragments useful in performing the detection process 270 of FIG. 2. At step 710 the aspect ratio for all text line fragments is calculated by the processor 1705. The local text line flow for the document image can then be calculated from properties of the text line fragments. Useful properties include the principle axis of the text line fragment, the length and the position of the text line fragment. A local text line flow can be calculated by creating a line centred on the centre point of the text line fragment, with angle equal to the principle axis of the text line fragment and length equal to the length of the text line fragment. The centre point of a text line fragment may be the centroid calculated from the image moments, or the centre of bounding box for a minimum rotated rectangle containing the pixels of the contained CCs for the text line fragment. The midpoint may also be calculated by averaging the centre of ellipses for the contained CCs. A principle axis can be calculated from the second order central moments, or as the angle of the longer axis of the minimum rotated rectangle containing the pixels of the contained CCs for the text line fragment, or as the regression line for the ellipse centrepoints for the contained CCs for the text line fragments.

At step 720 the principle axis for all text line fragments is calculated. At step 730 points are added to a Delaunay triangulation based on the principle axis and as the aspect ratio calculated at steps 720 and 710 respectively. One way to add points to a Delaunay triangulation is to add a point for each centre of mass for the text line fragments and a number of extra points along the principle axis that goes through the centre of mass. The number of extra points added for each text line fragment can be the rounded up aspect ratio, where the aspect ratio is expressed as the major (long) axis divided by the minor (short) axis of the text line fragment.

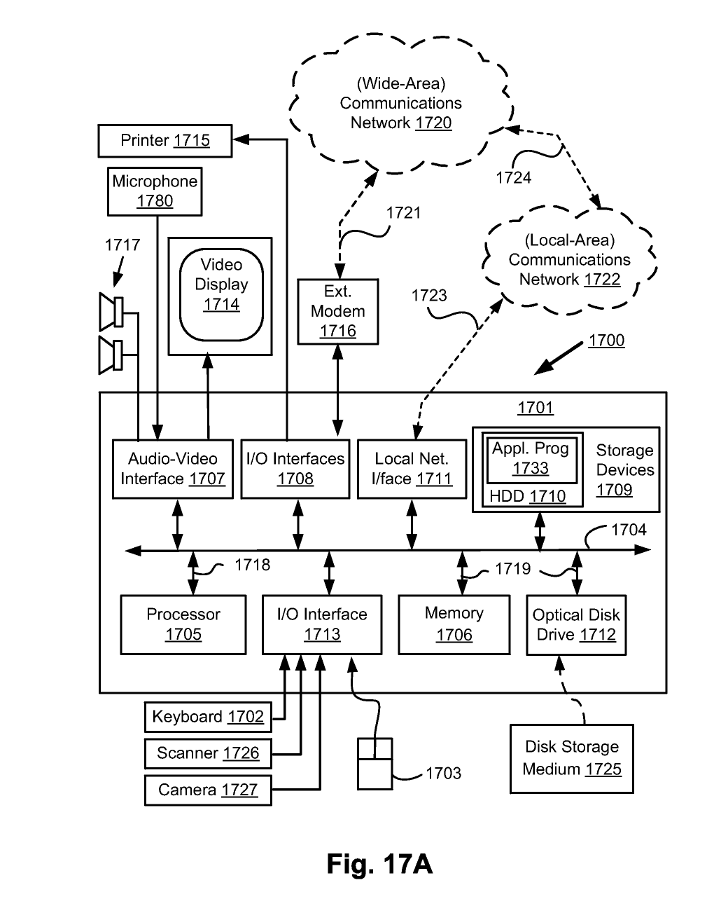

An example text line fragment shown in FIG. 16 shows how points can be added to a triangulation. The length, width and principle axis of a text line fragment are represented by ellipse 1610. The principle axis through the centroid of text line fragment 1610 is shown as line 1620. The centroid of the text line fragment 1610 is shown as point 1630, and extra points 1640 and 1650 are added on the principle axis line 1620 where it intersects with the ellipse 1610. Other points 1660 and 1670 are added on the principle axis line 1620 based on the aspect ratio of the text line fragment. Once the points 1630-1670 have been calculated, then a Delaunay triangulation and crust can be calculated at step 740. The crust is a sub-graph of a Delaunay triangulation, and is found by adding in the circumcentre points for all triangles in a Delaunay triangulation to a second Delaunay triangulation. The crust is then formed by the edges of the second Delaunay triangulation where both endpoints are not circumcentre points. Once the crust has been calculated for the points found in step 730, the crust can be used as a basis to form text lines at step 750. Initial text lines can be constructed where the crust forms a continuous non-forking line. A non-forking line is where each point in a crust has only two edges connected. Then the initial text lines can be extended from the endpoints based on the distance threshold and angle threshold of edges in the Delaunay triangulation. Once text lines have been formed at step 750, processing control returns to further processing step 280 from FIG. 2.

### Example(s)/User Case(s)

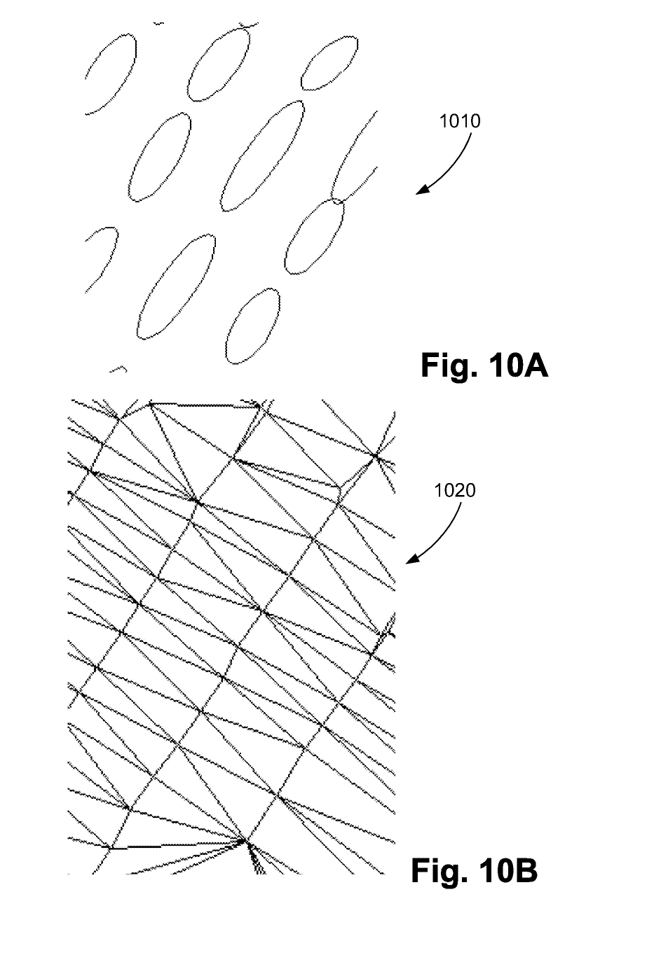

FIGS. 10A and 10B show the result of an implementation of the presently described arrangements applied to the CCs as shown in the image 910 of FIG. 9A. Text line fragments are shown in the image 1010 FIG. 10A and are represented as ellipses with the major and minor axes being the second order moments of the contained CCs for each text line fragment. The angle of the ellipses is the principle axis of the contained CCs for each text line fragment. The ellipses are centred over the centre of mass of the contained CCs for each text line fragment. Image 1020 of FIG. 10B shows a Delaunay triangulation based on the text line fragments shown in the image 1010. A local text line flow can be calculated from the text line fragments by adding points to a Delaunay triangulation along the principle axis of each text line fragment. The number of points added is proportional to the aspect ratio of the text line fragment.

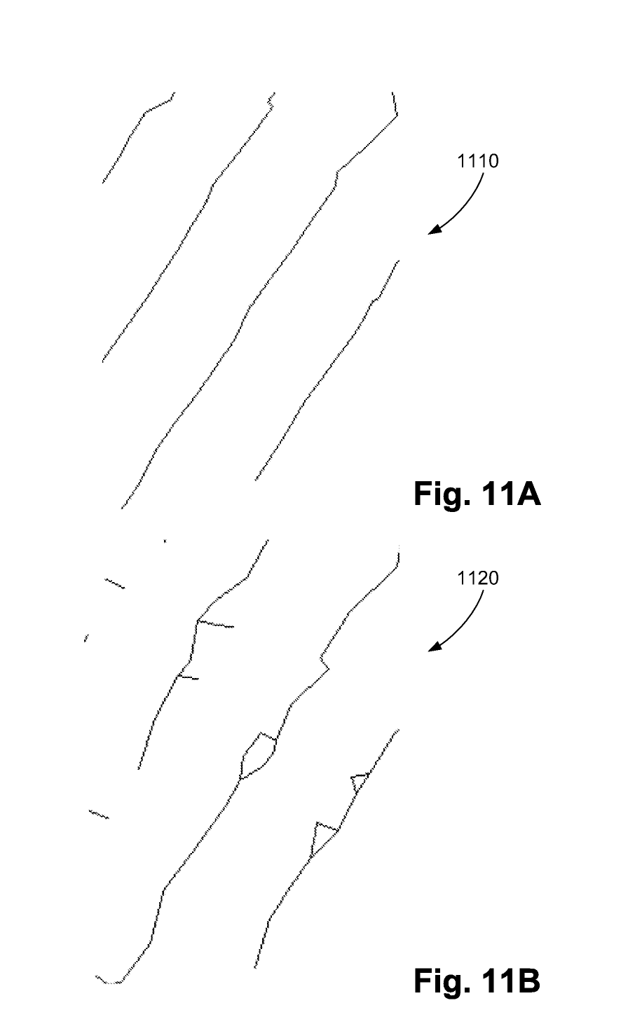

FIGS. 11A and 11B show the crust calculated from the Delaunay triangulations shown in images 1020 and 920. Image 1110 of FIG. 11A shows the crust calculated from the triangulation from the image 1020, and image 1120 of FIG. 11B shows the crust calculated from triangulation 920. The crust shown in image 1110 is better for use in detecting the text lines in the document image 820, and for calculating text line direction and curvature, compared to the crust shown in the image 1120. The text line direction can be determined from a direction of the principle axis of the text line fragments forming the text line.

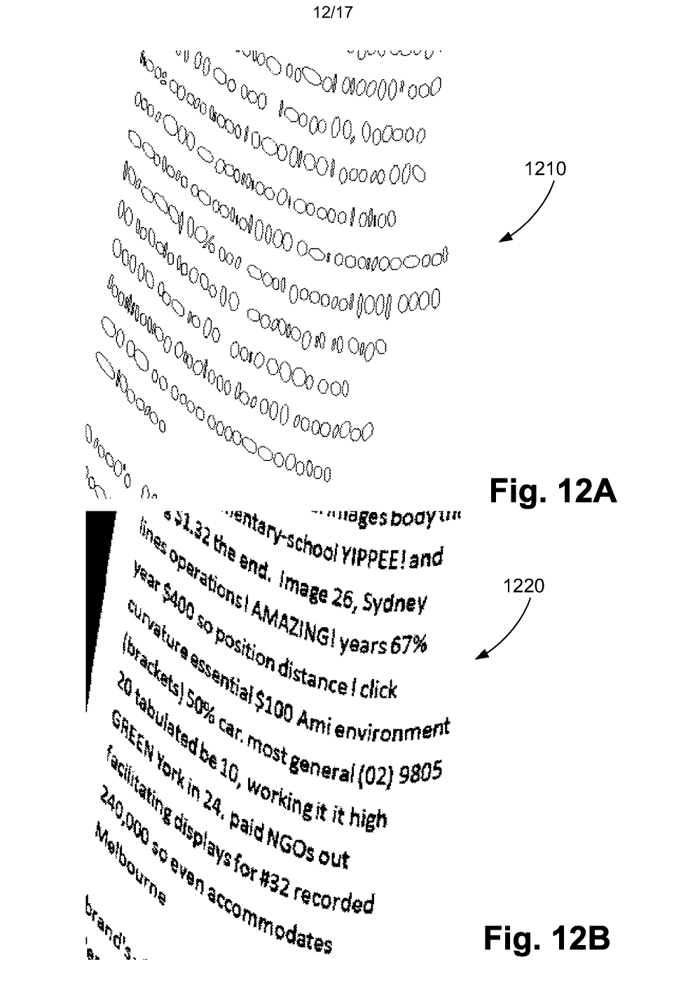

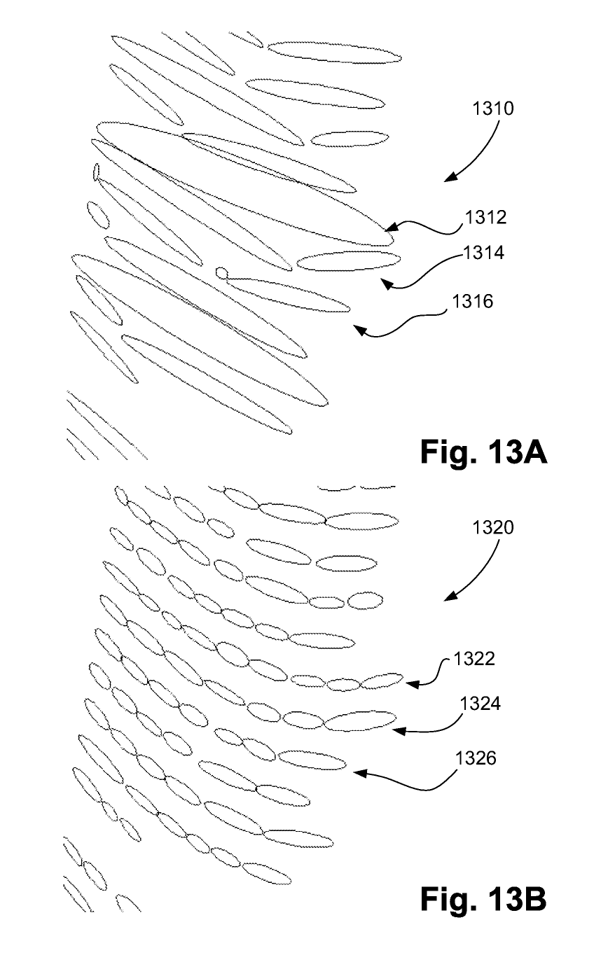

An example input document pixel image 1220 is shown in FIG. 12B, and the corresponding CC representation 1210 is shown in FIG. 12A. The CCs are represented by ellipses with the major and minor axes corresponding to the second order central moments of the CC and the angle of the ellipse corresponding to the principle axis for the CC. The ellipses are centred over the midpoint of the bounding box of the pixels of the CC. FIGS. 13A and 13B show two examples of text line fragments for the CCs shown in the representation 1210. Image 1310 of FIG. 13A shows text line fragments that have not been limited by a maximum aspect ratio, and image 1320 of FIG. 13B shows text line fragments that have been limited by a maximum aspect ratio. For example, in FIG. 13A, text line fragment 1312 has a relatively large aspect ratio, that in many respects encroaches onto adjacent lines of text, including that with the text line fragment 1314. Further fragments 1314 and 1316 are irregularly disjoint from adjacent fragments. By contrast, and as seen in FIG. 13B, by limiting the maximum aspect ratio for the text line fragments 1322, 1324, and 1326, corresponding to 1312, 1314 and 1316, significantly improved delineation of lines of text is achieved such that individual fragments are clearly indicative of local line flow. The text line fragments shown in image 1320 are much more suitable for using a dashed line method to detect whole text lines, and also allow a better approximation of local text line flow.

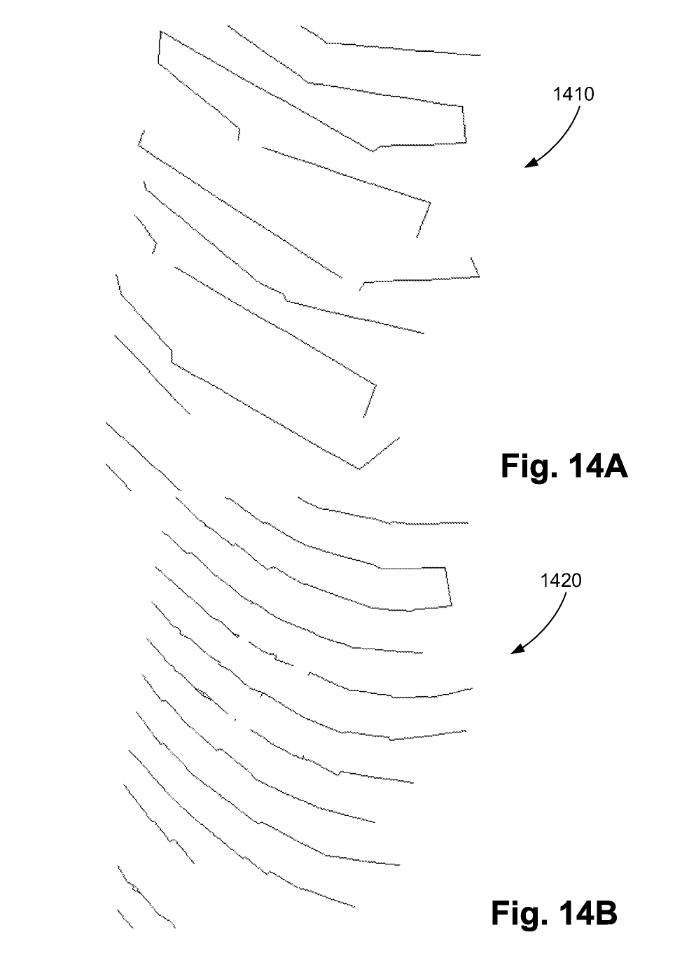

FIGS. 14A and 14B show the crust for the text line fragments shown in images 1310 and 1320. The crust was created by adding points to a Delaunay triangulation along the principle axis of each text line fragment. Image 1410 of FIG. 14A shows the crust corresponding to text line fragments shown in image 1310, and image 1420 of FIG. 14B shows the crust corresponding to text line fragments shown in image 1320. The crust shown in image 1420 is better for use in detecting the text lines in the document image 1220, and for calculating text line direction and curvature, compared to the crust shown in the image 1410, because the crust image 1420 displays greater lineal continuity.

### INDUSTRIAL APPLICABILITY

The arrangements described are applicable to the computer and data processing industries and particularly for the detection of text, and particularly lines of text, from images of documents.

The foregoing describes only some embodiments of the present invention, and modifications and/or changes can be made thereto without departing from the scope and spirit of the invention, the embodiments being illustrative and not restrictive.

1. A method of determining a local text line flow from an image of a document, the method comprising:
receiving a plurality of text connected components from the image;
forming text line fragments of the text connected components based on interconnection features between neighbouring text connected components of the plurality of text connected components, the text line fragments having a predetermined maximum aspect ratio; and
determining the local text line flow for the document based on a properties of the text line fragments.

2. A method according to claim 1, wherein each of the text line fragments are formed using text line fragments having an aspect ratio within the predetermined maximum aspect ratio.

3. A method according to claim 1, wherein the forming comprises at least one of merging text connected components to form a text line fragment, and splitting text line fragments into multiple text line fragments.

4. A method according to claim 1, wherein the forming comprises:
merging text connected components to form text line fragments; and
splitting text line fragments to provide for the text line fragments to have an aspect ratio within the predetermined maximum aspect ratio.

5. A method according to claim 1, further comprising determining the aspect ratio of a text line fragment using an image moment of the text line fragment.

6. A method according to claim 5, wherein the determining of the aspect ratio comprises calculating second order image moments using pixels of connected components contained in the text line fragment.

7. A method according to claim 5, wherein the determining of the aspect ratio comprises calculating image moments by summing pixel values weighted by position in the text line fragment.

8. A method according to claim 7 wherein
the zero'th order moment is the sum of the number of a set of pixels formed by one of an area of a connected components or a group of connected components,
the one-zero and the zero-one order image moments are the sum of a set of pixels weighted by x-position and y-position respectively.

9. A method according to claim 8 further comprising dividing the one-zero and zero-one image moments by the zero'th moment to provide the x-position and y-position respectively for the centroid of a set of pixels.

10. A method according to claim 9 comprising calculating the aspect ratio of a set of pixels using central moments, the central moments being calculated by summing pixels weighted by position which is offset by the centroid.

11. A method according to claim 5, comprising calculating the aspect ratio for a set of pixels by calculating the smallest rotated rectangle that contains all the pixels of the set, and using a ratio of the width and height of the rotated rectangle as the aspect ratio for the set of pixels.

12. A method according to claim 5, comprising approximating the aspect ratio of a text line fragment by counting the number of contained text connected components.

13. A method according to claim 1, wherein the determining of the local text line flow comprises generating a Delaunay triangulation from interconnection features associate with the text line fragments and calculating a curst for points in the triangulation, and using the crust to form text lines from the text line fragments.

14. A method according to claim 13, wherein the forming of text lines comprises associating text line fragments within a distance threshold of a line of the crust.

15. A method according to claim 13, wherein the forming of text lines comprises associating text line fragments within an angle threshold of a line of the crust.

16. A method of determining a local text line flow from an image of a document, the method comprising:
receiving a plurality of text CCs from the image;
forming text line fragments of the text CCs based on interconnection features between neighbouring text CCs of the plurality of text CCs;
forming sub-text line fragments by splitting the formed text line fragments according to an aspect ratio of the formed text line fragments and a comparison of a size of the text line fragment with a size of the text CCs forming the text line fragment; and
determining the local text line flow for the document based on a centre of each of the sub-text line fragments and a direction of an axis of each of the sub-text line fragments.

17. A non-transitory computer readable storage medium having a program recorded thereon, the program being executable by computerised apparatus to determine a local text line flow from an image of a document, the program comprising:
code for receiving a plurality of text connected components from the image;
code for forming text line fragments of the text connected components based on interconnection features between neighbouring text connected components of the plurality of text connected components, the text line fragments having a predetermined maximum aspect ratio; and
code for determining the local text line flow for the document based on a properties of the text line fragments.

18. A non-transitory computer readable storage medium having a program recorded thereon, the program being executable by computerised apparatus to determine a local text line flow from an image of a document, the program comprising:
code for receiving a plurality of text CCs from the image;
code for forming text line fragments of the text CCs based on interconnection features between neighbouring text CCs of the plurality of text CCs;
code for forming sub-text line fragments by splitting the formed text line fragments according to an aspect ratio of the formed text line fragments and a comparison of a size of the text line fragment with a size of the text CCs forming the text line fragment; and
code for determining the local text line flow for the document based on a centre of each of the sub-text line fragments and a direction of an axis of each of the sub-text line fragments.

19. Computerised apparatus comprising a processor and a memory, the memory having recorded therein a program executable by the processor for determining a local text line flow from an image of a document, the program being configured to implement the method steps of:
receiving a plurality of text connected components from the image;
forming text line fragments of the text connected components based on interconnection features between neighbouring text connected components of the plurality of text connected components, the text line fragments having a predetermined maximum aspect ratio; and
determining the local text line flow for the document based on a properties of the text line fragments.
